(19) United States
(12) Patent Application Publication
(10) Pub. No.: US 2008/0282907 A1
(43) Pub. Date: Nov. 20, 2008

(54) Rechargeable Food Chilling Device

(75) Inventors: Jason Ernest Begin, Mooresville, NC (US); Robert Grant McRorie, III, Huntersville, NC (US)

Correspondence Address: LEMPIA BRAIDWOOD LLC, 223 W. JACKSON BLVD., SUITE 620, CHICAGO, IL, 60606, US

(73) Assignee: Rubbermaid Incorporated, Huntersville, NC (US)

(21) Appl. No.: 12/105,167

(22) Filed: Apr. 17, 2008

Related U.S. Application Data
(60) Provisional application No. 60/912,401, filed on Apr. 17, 2007.

(51) Int. Cl. A47J 43/00; B65D 8/00; B65D 25/28; B65D 41/04

(52) U.S. Cl. 99/485; 220/669; 220/772; 220/288

(57) ABSTRACT

A food chilling device has a generally cylindrical elongate body with an outer wall, a closed end, an open end, a reservoir within the outer wall between the open and closed ends, and a reference axis oriented lengthwise between the open and closed ends. A closure assembly is removably installed on the device to close off the open end of the body and to seal the reservoir. In one example, a first handle extends outward in a radial direction relative to the reference axis of the body and has a first grip spaced outward beyond the outer wall. A second handle extends in a lengthwise direction and has a second grip spaced from the open end of the body. In another example, the closure assembly has an annular collar surrounding the open end of the body and with an inward extending circumferential shoulder. A cap with a stopper section engages the collar to close off the open end of the body. A seal is compressed against the step such that the step and seal are sandwiched between the shoulder of the collar and a surface on the stopper section to seal the reservoir.

### RELATED APPLICATION DATA

This patent is related to and claims priority benefit of U.S. provisional application Ser. No. 60/912,401, which was filed on Apr. 17, 2007, and which is hereby incorporated by reference in its entirety.

### BACKGROUND OF THE INVENTION

1. Field of the Disclosure

The present disclosure is generally directed to chilling food in a restaurant or commercial kitchen environment, and more particularly to a rechargeable food chilling device for rapidly chilling cooked food products for later reheating and serving.

2. Description of Related Art

Hazard Analysis Critical Control Points (HACCP) provides food safety standards. These standards are generally enforced by government agencies such as U.S. Department of Agriculture entities including the Food and Safety Inspection Service (FSIS) and the Food and Drug Administration (FDA). HACCP provides a scientific process control system to eliminate or remove contaminants in critical areas of food production and distribution processes. HACCP helps to prevent harmful contamination in the food supply, including within the commercial restaurant environment. For example, HACCP food safety standards define a temperature danger zone for foods between 70° and 140° Fahrenheit (F). It is within this temperature range that food borne, illness causing, bacteria are most likely to grow.

Many types of food are cooked in large quantities in commercial kitchens and are retained above the 140° threshold, ready to be served throughout the day. Examples of this type of food can include soups, pasta sauces, chili, and the like. Leftover quantities are often chilled and stored to be reheated and served the next day. Food codes or regulations state that, during a cooling or rapid chilling process, operators must bring the temperature of such a food product from 140° to 70° within the first two hours of the cooling process. Remaining within this danger zone for too long can risk the food becoming contaminated. Once cooled to below the 70° threshold, the operator is free to put the food into a cooler to complete the second stage of the cooling process.

One type of product that is used to achieve this relatively rapid chilling or cooling down of the food product is known as a chill stick or ice stick. Ice sticks are used to assist in the first stage of the cooling process to bring the food down to the 70° threshold within the allowable two hour window. Existing products in the marketplace are barely able to accomplish this because the cold energy that they are able to store can be equally offset by the heat energy of the food product. The existing products also can be difficult to fill, are not very durable, and can take time to prepare (i.e., freeze) for use. Thus, quite a number of these known products must be kept on hand to meet the needs of a typical food kitchen.

U.S. Pat. No. 5,058,396 discloses one such existing product in the form of a plastic wand that has a narrow neck/handle at one end and a small opening in the neck. This known product has an inner chamber that can be filled with liquid via the opening. The opening can then be sealed with a cap, held by the neck, and placed in a freezer to be frozen for use. The product must be filled with water and then frozen, which is a time consuming process. The product can not be filled with ice. This known device also has axially spaced groves over the body of the wand that are intended to increase the surface area in contact with the food to improve its cooling efficiency. The lone handle at one extreme end of the product can also make it cumbersome to handle the product when frozen.

These known devices tend to break rather easily if dropped or if used through a number of freeze and melt cycles. The plastic material transfers heat from the food to the frozen material inside the device, rapidly reducing the effectiveness of the device as a chilling product. Once the refrigerant melts or warms, the device can no longer be used until it is refrozen. These devices also are quite large and take up a lot of storage space when not being used. The devices also take up a lot of freezer or walk-in cooler space when being prepared for use. Because they must be frozen and are quite large, the devices often are left to freeze overnight, which is time consuming and which takes up a lot of valuable freezer space during the next day until there is a cooling need. Breakage can be an issue if it occurs during a cooling cycle because there is a great risk of food contamination if the unit leaks. These devices are also awkwardly shaped and difficult to store in a sanitary manner.

### BRIEF DESCRIPTION OF THE DRAWINGS

Objects, features, and advantages of the present invention will become apparent upon reading the following description in conjunction with the drawing figures, in which:

FIG. 1 is a perspective view of one example of a food chilling device constructed in accordance with the teachings of the present invention.

FIG. 2 is an exploded perspective view of the food chilling device in FIG. 1.

FIG. 3 is aside, partial cut away view of the food chilling device in FIG. 1.

FIG. 4 is a detail view of a portion of the food chilling device taken from Circle IV-IV in FIG. 3.

FIG. 5 is a side view of the food chilling device in FIG. 1, partially disassembled and being filled with ice.

FIG. 6 is a side view of the food chilling device in FIG. 1 and arranged in one possible orientation of use to chill a vessel of food.

FIG. 7 is a side view of the food chilling device in FIG. 1 and arranged in another possible orientation of use to chill a vessel of food.

FIG. 8 is a side view of the food chilling device in FIG. 1 resting on a surface between uses.

FIG. 9 is a graph comparing cooling characteristics of stainless steel and plastic for the food chilling device example disclosed herein.

FIG. 10 is one alternative example of a device body stacking arrangement that can be achieved by the food chilling device disclosed herein.

FIG. 11 is one alternative example of a device collar stacking arrangement that can be achieved by the food chilling device disclosed herein.

### DETAILED DESCRIPTION OF THE DISCLOSURE

Examples of an improved food chilling device are disclosed and described herein. The disclosed devices offer the capability of being recharged using ice, water, or a mixture of both. The disclosed devices can also be filled and recharged as needed and immediately at the time of need. If the refrigerant warms to the point of ineffectiveness, the devices can immediately be recharged and reused. Thus, the disclosed devices can be recharged during use or can be used, emptied, and recharged with ice to be ready for use almost immediately. In one example, the disclosed devices will not break during normal usage or cleaning. In other examples, the disclosed devices can offer more efficient cooling materials, easier handling, lid safety and convenience features, and a shape that is more easily stored, maneuvered, and handled.

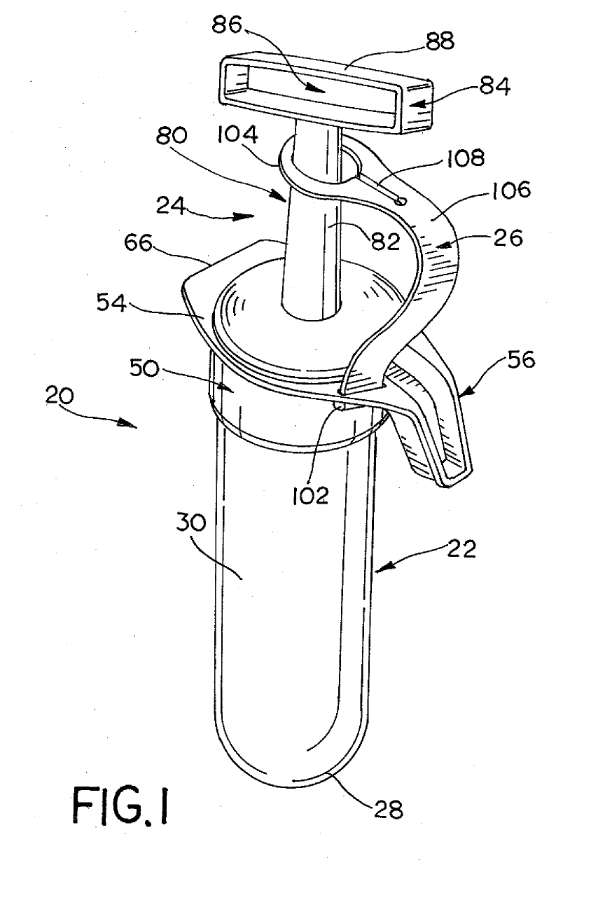

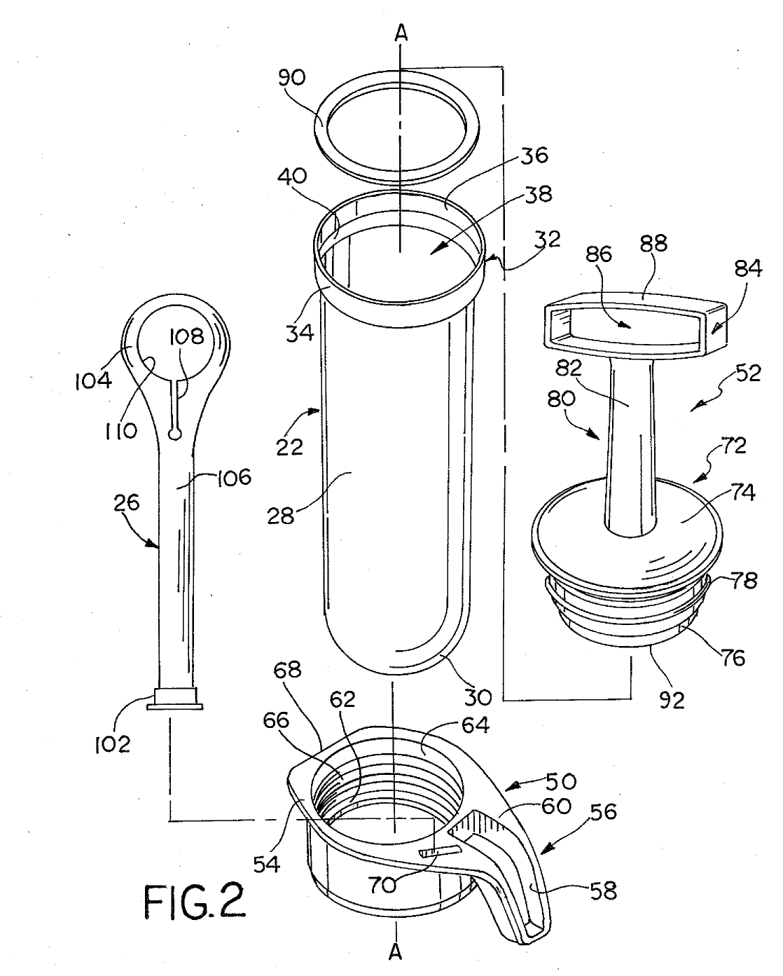

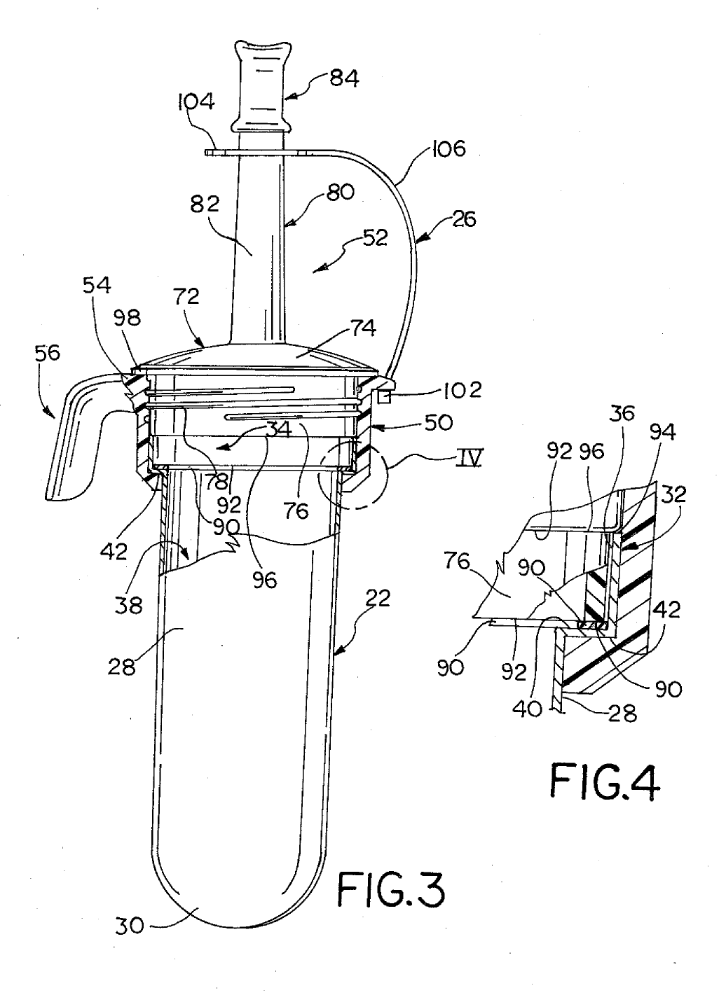

Turning now to the drawings, FIG. 1 shows one example of a food chilling device 20 constructed in accordance with the teachings of the present invention. In this disclosed example, the device 20 generally includes a body 22, a closure assembly 24, and a strap or tether 26. FIG. 2 shows an exploded view of the device 20. The body 22 in the disclosed example is a cylinder or tube shape with a closed end 28, an outer wall or side wall 30, and an open end 32. As shown in FIG. 2, the open end 32 in this example has a larger diameter rim section 34 of the outer wall 28 that defines an access opening 36 into the body. The opening provides access to a reservoir 38 within the body defined within the confines of the outer wall 30, the closed end 28, and the open end 32. In the disclosed example, the rim section 34 is joined to the smaller diameter outer wall 28 at a step or shoulder near the open end 32. An upward facing surface 40 is created by the step within the interior of the rim section 34 and faces the top opening 36. A downward facing surface 42 is also created by the step below the rim section 34 on an exterior of the outer wall that faces away from the top opening 36 (see FIGS. 3 and 4). The body 22 in this example has a central reference axis A that is oriented extending a longitudinally along the body from a closed and 30 in the open and 32.

As will be evident to those having ordinary skill in the art, the body 22 can vary in configuration and construction within the spirit and scope of the present invention. In one example, the body can be formed as a stainless steel cylinder. However, the body can be formed of other materials such as plastic, aluminum, composite, metal alloys, or other suitable materials. In one example, the body can be formed as a circular cylinder with a circular cross-section as shown. However, the cross-section of the body or cylinder shape it need not be circular, but instead can be a non-circular cylinder shape such as oval, rectangular, square, or the like. The body 22 in the disclosed example is also illustrated having a generally consistent diameter over its length between the top rim section 34 and the closed bottom end 30. However, the body can be tapered so that it is wider or has a slightly larger diameter near the open end as compared to the diameter at the closed end. A slight taper in the body 22 can assist in manufacturability and can permit a stacked arrangement of multiple nested bodies 22.

In the disclosed example, the closure assembly 24 generally has a collar 50 and a cap 52. In the disclosed example, the collar is in the form of a funnel or ring that is open both at the top and at the bottom. An annular flange or rim 54 projects outward from a perimeter of the collar 50 at its top end. The flange 54 extends circumferentially around the collar 50. A first handle 56 projects from a portion of the flange 54. In this example, the first handle 56 is generally L-shaped and has a first grip 58 integrally connected to and extending from a leg 60 projecting from the flange 54. In this example, the grip 58 extends from the leg 60 in a direction downward toward a bottom of the collar 50 and is cantilevered from the leg.

As shown in FIGS. 2-4, an annular shoulder 62 extends radially inward from the perimeter of the open bottom end of the collar 50. An interior surface 64 of the collar 50 in the disclosed example includes mechanical threads 66 that define a female thread on the interior of the collar. The edge of the flange 54 opposite the first handle 56 has a generally flat surface 68, a function of which is described below. In addition, a tether opening 70 is formed through a portion of the flange 54, the purpose of which is also described below. In this example, the tether opening 70 is positioned in a portion of the flange 54 that defines or is positioned near the leg 60 of the first handle 56.

In the disclosed example, the collar 50 is an integral or one-piece molded plastic component. However, the collar 50 can be formed of other stock including stainless steel, composites, aluminum, metal alloys, or other materials. In another example, the collar 50 and handle 56 can be formed as separate components that are fastened or otherwise connected to one another. The configuration of the rim or flange 54, the shape of the collar 50, and the shape and structure of the handle 56 can also vary within the spirit and scope of the present invention. The molded parts can include features to add strength and rigidity and/or to reduce the amount of material used to form the parts. In this example, the handle 56 has a central opening between a pair of side bars and above a bottom bar connecting the side bars and is substantially rigid and strong and yet significantly reduces the amount of material to form the handle.

As illustrated in FIGS. 1-4, the collar 50 can be slipped over the closed end 30 of the body 22 and then slid up the body until the shoulder 62 abuts against the bottom surface 42 on the step in the outer wall 28 of the body. Contact between the step and the shoulder 62 properly positions the collar 50 vertically along the body 22 of the assembled device 20. The position and orientation of the first handle 56 provides a comfortable gripping location for holding the device 20 in a conventional manner for filling, recharging, or placement of the device during use or storage.

In the disclosed example, the cap 52 generally has a stopper section 72 with a cover 74 defining a top surface and a cylindrical plug 76 projecting from an underside of the cover. As shown in FIG. 2, the plug 76 has external mechanical threads 78 on its outer surface that define a male thread on the cap 52. A second handle 80 projects upward from the top surface of the cover 74 and in this example is aligned with the reference axis A when the device 20 is assembled. In this example, the second handle 80 is generally T-shaped and has a stem 82 projecting from and connected to the cover 74 and a second grip 84 coupled to a free or distal end of the stem. The stem 82 is aligned with the reference axis A and the second grip 84 is oriented generally perpendicular to the stem in this example. The second grip 84 is formed as a loop with the center opening 86. The entire loop can define the second grip 84 in this example. Alternatively, the uppermost segment 88 of the loop can be configured to define the second grip. As will be evident to those having ordinary skill in the art, the overall configuration of the second handle, including the second grip, can vary within the spirit and scope of the present invention. In one alternative example, the second grip 84 can be a solid cylinder or slug of material connected to the stem 82.

In the disclosed example, the cap 52 is also an integral or one-piece molded plastic component. As with the collar 50, the cap 52 can be formed from other stock including stainless steel, composites, aluminum, metal alloys, or other suitable materials. In addition, the cap 52 can be formed of multiple separate pieces that are fastened or otherwise interconnected to one another.

In the disclosed example, the cap 52 can be positioned over the collar 50. The threaded plug 76 can then be placed into the open top of the collar 50 and can be threaded into the collar with the male threads 78 and the female threads 66 engaged. The T-shaped handle 80 can be easily gripped and rotated to install and remove the cap 52 from the collar 50 when needed. The T-shaped second handle 80 also provides a firm second gripping location for a user to grasp, hold, and manipulate the device 20 during use. Other advantages of the handles 56 and 80 are discussed in greater detail below.

A watertight seal can be provided as part of the closure assembly 24 to seal the reservoir when the device 20 is assembled as in FIG. 1. The device can be configured to create adequate seals upon assembly. In one example best illustrated in FIGS. 2-4, a primary compression seal 90 in the form of an O-ring can be positioned between the body 22 and part of the closure assembly 24. As shown in FIG. 2, the seal 90 can be a separate component that is positioned on the upward facing step surface 40 within the top opening 36 in the body 22. A portion of the closure device can be configured to compress the seal 90 when assembled, such as when the cap 52 is installed. In this particular example, the collar is positioned on the exterior of the body abutting the bottom surface 42 of the step. The cap 52 can be screwed into the collar 50, which draws the collar upward and pulls the cap downward. A bottom edge 92 on the plug 76 of the cap is thus drawn downward against the seal 90 toward the surface 40 on the step, which compresses the seal. The components can be sized and arranged to create an essentially watertight seal for the reservoir. As shown in FIG. 2, the entire device 20 can be disassembled for thorough cleaning of virtually every surface and crevice of the device when needed.

In another example, the seal 90 can be replaced by a co-molded or dual molded material ring provided directly on the underside or bottom 92 of the plug 76. In another example, the seal 90 can be provided as part of the step in the body 22, if desired. The surface contours of the seal 90, the body surface 40, and the plug surface 92 can be altered to create circuitous mating seal surfaces or can be essentially flat and rely upon compression of the seal 90 and contact between the mating flat surfaces.

As represented in FIGS. 3 and 4, optional and/or secondary seals can also be provided on the device as well. In one example, the top edge 94 of the body 22 can abut a ridge 96 on the outer surface of the plug 76. This contact line between closure assembly 24 and body 22 can also optionally be provided with a separate O-ring seal (not shown) on the exterior of the plug 76, or with a co-molded or dual molded ring of sealing material along the ridge 96. In another example, a cover seal 98 can be provided around the perimeter of the cover 74 to create a seal sandwiched between the cover and the rim or flange 54. The cover seal 98 can again be a separate O-ring carried on either the cover 74 or the collar 50, or can be a co-molded or dual molded surface of a sealing material on either one of the two parts. Other seal and closure assembly arrangements can be employed within the spirit and scope of the present invention.

Also as shown in FIGS. 1-5, the tether 26 can be employed to connect the removable cap 52 to the collar 50 or the body 22. In this example, the tether 26 has one end with a catch part or anchor 102 sized to forcibly fit through the tether opening 70 on the collar 50. In this example, the tether opening 70 is a slot and the anchor 102 is a slug that has a width sufficient to fit lengthwise through the slotted opening 76, but a length that is longer than the opening. Once through the opening, the anchor retains the tether 26 to the collar 50. The tether 26 also has a ring 104 at its opposite end connected to the anchor by a strap 106. The ring 104 is configured to forcibly fit onto the stem 82 of the second handle 80 on the cap 52. In this example, a slit 108 is formed extending from the interior edge 110 of the ring 104 along the strap 106. The slit allows the ring opening to temporarily expand and fit over the second handle 80 and onto the stem 82 as shown in FIG. 1.

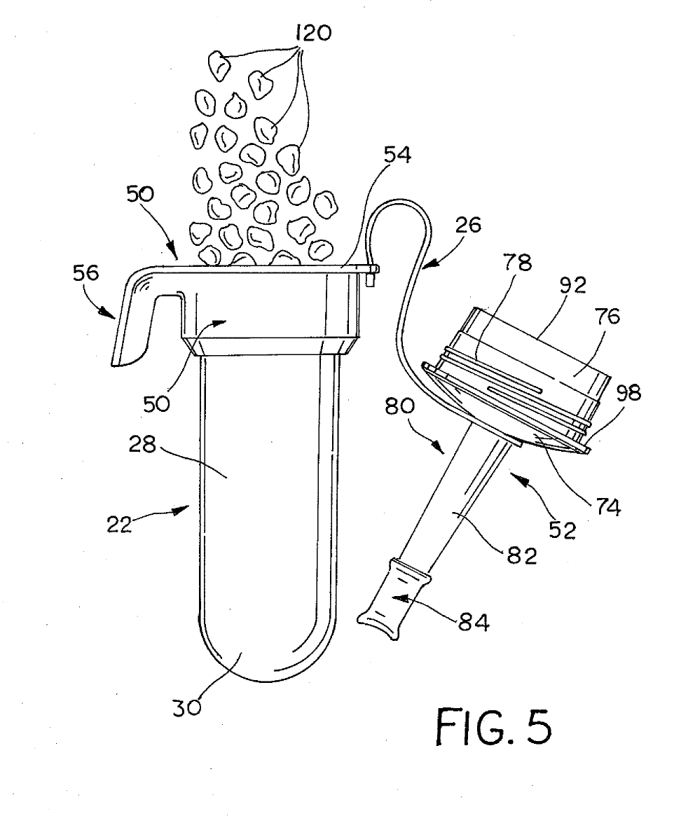

As shown in FIG. 5, the tether conveniently retains the cap 52 attached to the collar 50, and thus the body 22, even when removed from the collar. The tether 26 can be handy to prevent the cap 52 from being lost or misplaced when removed or from falling into a food container and contaminating the food. Having to remove a wayward cap 52 from a container of food could potentially contaminate the food because the cap may have been touched by many hands, have ice or water residue on it, and/or have been in contact with many different surfaces in the kitchen environment. As will be evident to those having ordinary skill in the art, the tether 26 can vary in size and structural and functional features within the spirit and scope of the invention.

The disclosed food chilling device 20 provides a number of additional advantages and benefits. In one example illustrated in FIG. 5, both the body 22 and the collar 50 have a large sized, wide opening so that it can be easily filled with ice 120, water, or both. The device can also be filled without having to disassemble the components, other than having to remove the cap 52. The ice 120 can simply be scooped into the cooling chamber of the body 22 immediately upon determining a need for the device. During cooling, heat from the food can warm the ice/water or other coolant mixture in the reservoir 38 to a point at which the coolant is no longer effective. If this occurs, the cap 52 can be removed, the reservoir can be recharged, and the same device can be immediately replaced in the receptacle to continue rapid cooling of the food.

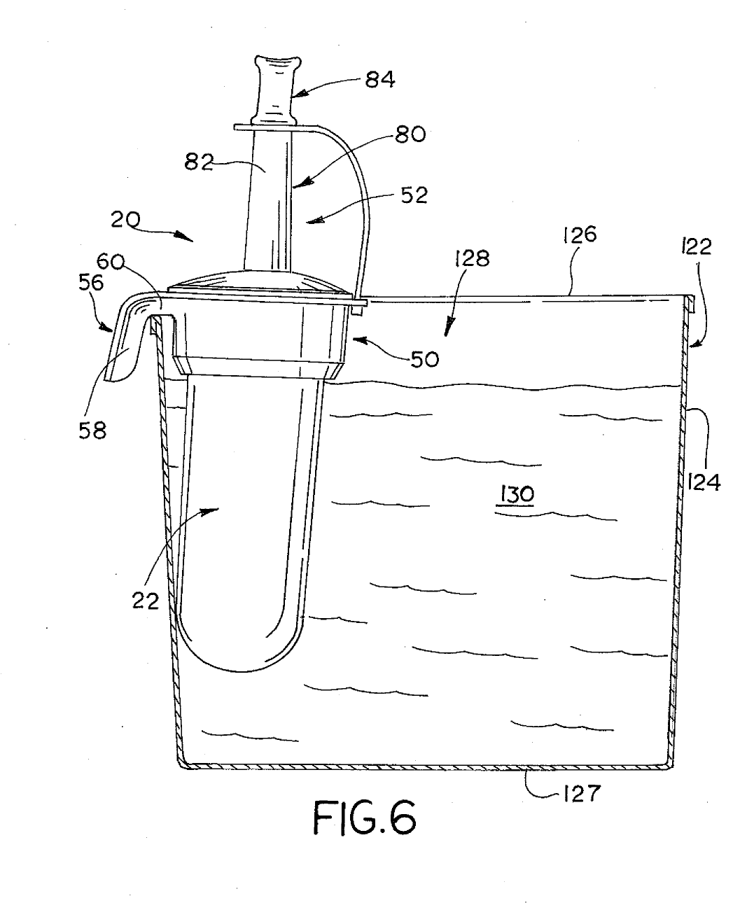

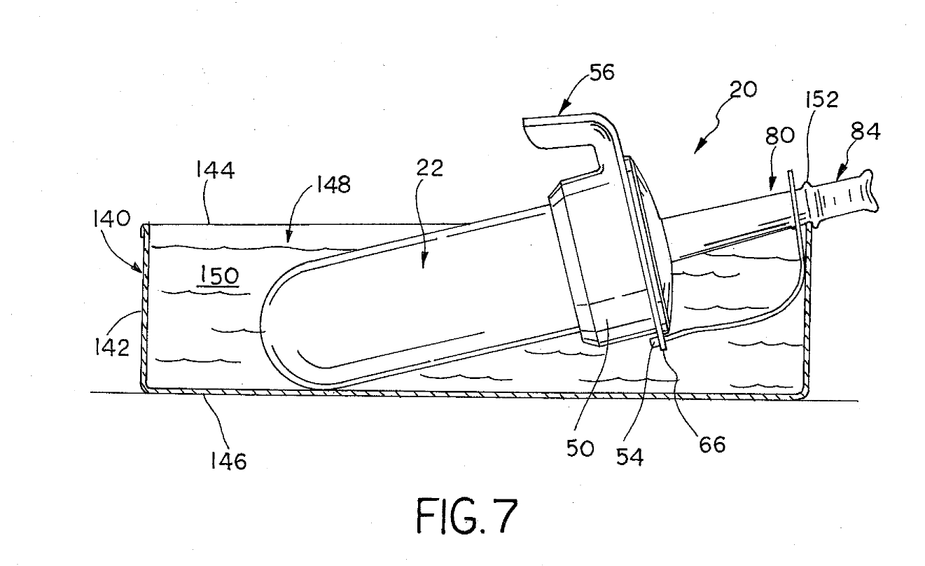

In another example, the first handle 56 and the second handle 80, separately and/or in combination, can make it relatively easier and comfortable for the operator to hold and move the device 20 without their hands coming into contact with the food being cooled. The handles 56 and 80 are sized, oriented, and positioned so as to be capable of being clear of the food and its container during use, as represented in FIGS. 6 and 7. An operator can hold the device 20 by either or both of the handles 56, 80 and place the body 22 into the food, depending on the characteristics of the food receptacle.

The grip 58 of the first handle 56 is spaced from the body and positioned near the top of the device 20, which can make it easy for the operator to hold the device with one hand for carrying and placement on a surface or in a food container. The inverted L-shaped handle 56 in this example also creates a hook to hang or suspend toe device 20 during use. With reference to FIG. 6, a rather tall food vessel 122 might typically have a side wall 124 with a top edge 126, a bottom 127, and an interior 128 above the bottom within the side wall. Food 130 can be held in the interior 128 during cooking, serving, cooling, and storing. As shown, the handle 56 of the device 20 can simply be hooked onto the top edge 126 of the side wall 124 with the device suspended nearly vertically and the body submerged in the food 130 for cooling. To do so, the grip 58 of the handle 56 is positioned outside the vessel with the leg 60 resting on the top edge. The operator can position and remove the device 20 from this in use orientation using either or both of the handles 56, 80 because both are clear of the food 130.

With reference to FIG. 7, a rather low food vessel 140 might typically have a short side wall 142 with a top edge 144, a bottom 146, and an interior 148 above the bottom within the side wall. Again, food 150 can be held in the interior 146 during cooking, serving, cooling, and storing. As shown, the handle 80 can be laid on the top edge 144 of the vessel wall 142 with the device lying nearly horizontally and the body 22 submerged in the food 150. In this example, the stem 82 or other handle surface can have a flat section (though not shown) to keep the handle 56 from rolling into the food 150. The stem 82 or other handle part can also have a stop rib 152 or other protrusion to keep the device from sliding completely into to food if desired. On the other hand, the vessel 140 may be of a low enough height that the device 20 can be laid directly on the bottom 146 of the vessel with the handle 56 directed upward as shown.

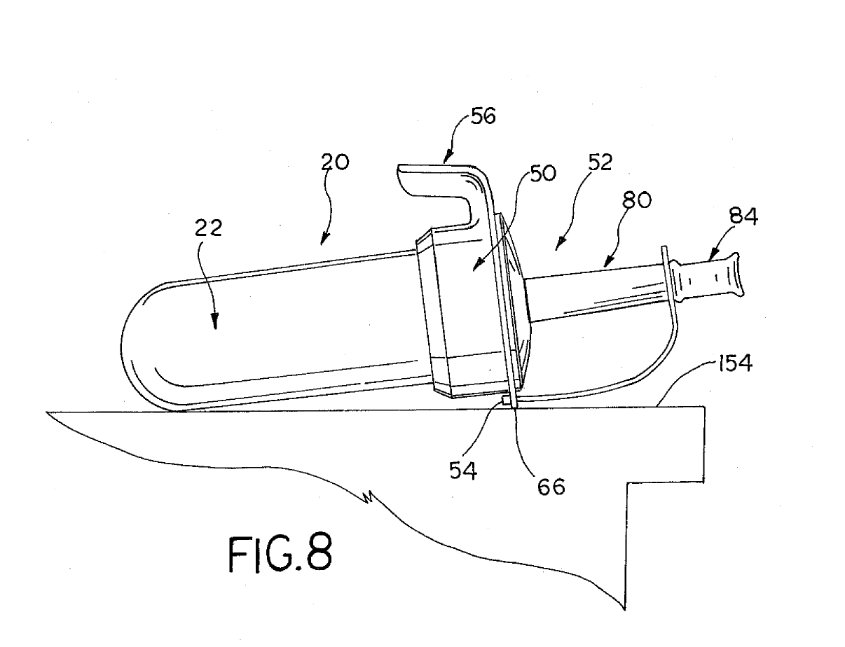

With that in mind and turning to FIG. 8, the disclosed device can be laid on any flat surface, such as a counter top 154 or the bottom 146 of a low height vessel 140. With the handle 56 directed upward as shown, the previously described flat surface 66 on the flange 54 of the collar 54 will rest on the surface 154 or 146. The flat will keep the device from rolling and, thus, will keep the handle 56 out of contact with the surface and/or the food. Turning back to FIGS. 1 and 2, the perimeter of the rim or flange 54 of the collar 50 can be a non-round shape to act as an anti-roll feature. Thus, during use the anti-roll feature can prevent the device 20 from shifting or rolling to a position where the side grip handle or first handle 56 is immersed in food or in contact with a potentially contaminated surface.

The perimeter edge of the rim or flange in this example is non-circular in shape to provide the anti-roll feature. The perimeter shape of the flange 54 can vary considerably and yet provide such a feature. The anti-roll feature can also be provided on the body 22 or some other part of the device as well. If cleanliness is not an issue at a given time, but anti-rolling is a concern, the disclosed device 20 can also be laid on either side, resting in part with a side of the handle 56 abutting the surface, without the device rolling along the surface. In another example (not shown), the device 20 can be provided with a part, such as the collar flange 54, that has a tri-lobe shape and function in the same manner. Other modifications to the disclosed anti-rolling shapes and features are also within the scope and spirit of the present invention.

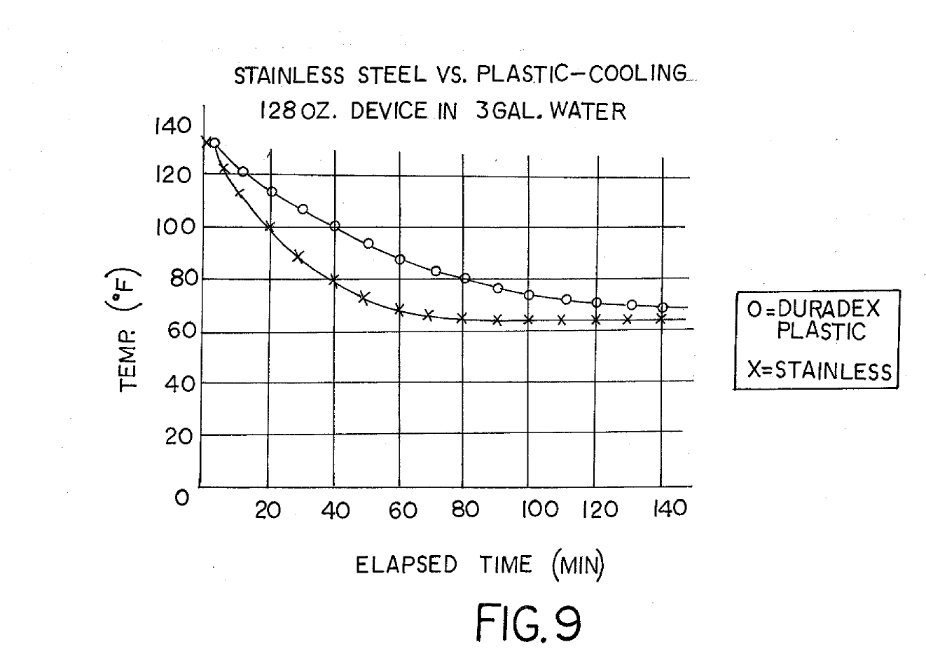

In addition, the stainless steel nature of the body 22 of the device 20 in this example can provide superior cooling efficiency over the prior known plastic devices. FIG. 9 graphically illustrates improved cooling efficiency in comparison to a plastic bodied device. The device 20 in this example can more efficiently transfer heat from the food into the cooling chamber of the device. As shown, a steel bodied device can bring food in a vessel from above the 140° F. safe serving threshold to below the 70° F. safe storage threshold in about 60 minutes. In contrast, a like sized plastic bodied vessel will bring the food in the same vessel from 140° F. to 70° F. in about 110-120 minutes. Stainless steel or other metals can be used for the body and achieve more rapid cooling of food in comparison to plastic. However, the device 20 disclosed herein can be formed with a plastic body 22 if desired to reduce cost.

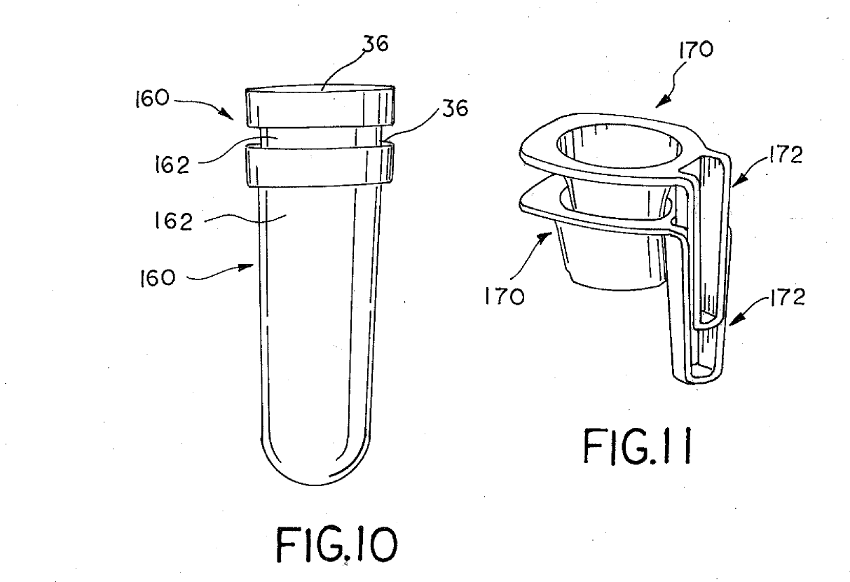

As shown in FIG. 10, the disclosed devices can employ the above-described tapered cylinder shaped side walls 162 in a body 160. Such a body shape can offer a storage arrangement that utilizes significantly less space than conventional cooling devices. As noted above, the bodies 160 can be tapered and have wide top openings 36. Thus, multiple bodies 160 in such an example can be stacked and nested within one another. As shown in FIG. 11, collars 170 can also be similarly tapered and the handles 172 can be tapered and scalloped to permit nesting and stacking, as long as the caps are removed. The nested stacking arrangement of these food chilling device components can save significant shelf space when the devices are not being used.

Also, the disclosed devices 20 can be stored until ready to be used. The devices can immediately be charged or recharged with ice or another refrigerant or mixture for use. The devices do not need to be pre-frozen prior to use. The disclosed devices also do not require taking up freezer or walk-in cooler space and thus can be stored compactly on a shelf, out of the way of the kitchen staff until needed.

Any suitable manufacturing methods can also be used to form the body 22, cap 52, and collar 50 and the methods can be dependent on material selection for each component. In one example, both the cap 52 and the collar 50 can be injection molded from a plastic material with high impact resistance. The body 22, if stainless steel, can be fabricated from any suitable process. In one example, the body can be roll formed as a tapered tube. A hemi-spherical bottom cover can be welded to the bottom of the tube. The surfaces including the welds can be ground and polished, if desired. A smooth exterior finish on the outer wall 28 will be easier to thoroughly clean to assist in preventing food contamination.

In other alternative examples, the collar 50 and its side handle 56 can be a permanently attached or integrally formed part of the body 22. The T-shaped handle 80 of the cap 52 can be formed integral with the cap, permanently attached to the cap, removably attached to the cap, or provided as part of another component of the device 20, such as the collar 50 or the body 22.

Although certain food chilling devices have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A food chilling device comprising:
a generally cylindrical elongate body with an outer wall, a closed end, an open end, a reservoir within the outer wall between the open and closed ends, and a reference axis oriented lengthwise between the open and closed ends;
a closure assembly removably installed on the device to close off the open end of the body and to seal the reservoir;
a first handle extending outward in a radial direction relative to the reference axis and having a first grip spaced outward from the outer wall; and
a second handle extending in a lengthwise direction and having a second grip spaced from the open end of the body.

2. A food chilling device according to claim 1, wherein the body is a circular cylinder in cross section.

3. A food chilling device according to claim 2, wherein the circular cylinder is tapered such that the diameter of the cylinder nearer the closed end is smaller than the diameter of the cylinder nearer the open end.

4. A food chilling device according to claim 1, wherein the cylinder has a step formed around an interior surface and facing the open end, and wherein the closure assembly has a seal that compresses against the step when closing off the open end.

5. A food chilling device according to claim 1, wherein the cylinder is formed of a stainless steel material.

6. A food chilling device according to claim 1, wherein the closure assembly includes a removable cap and the second handle extends from a top surface of the cap.

7. A food chilling device according to claim 6, wherein the second handle is a generally T-shaped handle with a stem connected to the cap and a ring on a free end of the stem, an uppermost section of the ring oriented generally perpendicular to the stem and forming the second grip.

8. A food chilling device according to claim 7, wherein the first grip of the first handle is arranged generally parallel to the outer wall of the body and is spaced laterally outward from the outer wall near the open end.

9. A food chilling device according to claim 1, wherein the first grip of the first handle is arranged generally parallel to the outer wall of the body and is spaced laterally outward from the outer wall near the open end.

10. A food chilling device according to claim 19, wherein the first handle is generally L-shaped with the second grip having one end connected by a leg to the device near the open end and an opposite end that is cantilevered from the leg and extends toward the closed end of the body.

11. A food chilling device according to claim 1, further comprising a generally flat rest surface located opposite the first handle on the device and near the open end of the body.

12. A food chilling device according to claim 1, wherein the closure assembly comprises:
a removable collar surrounding the open end of the body, the collar having a female threaded circumferential surface and an annular shoulder extending inward around the collar; and
a cap with a stopper section having a male threaded circumferential surface configured to engage the female threaded circumferential surface with the cap connected to the collar,
wherein a step in the outer wall near the open end of the body is captured between the annular shoulder of the collar and a surface on the stopper section with the cap connected to the collar.

13. A food chilling device according to claim 12, wherein a seal is compressed between the step and the surface on the stopper section with the cap connected to the collar.

14. A food chilling device according to claim 12, wherein the cap has a cover connected to the stopper section and wherein a seal is compressed between a surface on the collar and the cover with cap connected to the collar.

15. A food chilling device according to claim 12, further comprising a tether connecting the cap to the collar.

16. A food chilling device comprising:
a tube shaped elongate body with an outer wall, a closed end, an open end, a reservoir between the open and closed ends, an outward step in the outer wall near the open end, and a reference axis oriented lengthwise between the open and closed ends;
an annular collar surrounding the open end of the body and having an inward extending circumferential shoulder;
a cap with a stopper section that engages the collar to close off the open end of the body with the cap connected to the collar; and
a primary seal compressed against the step, wherein the step and the seal are sandwiched between the shoulder of the collar and a surface on the stopper section to seal the reservoir with the cap connected to the collar.

17. A food chilling device according to claim 16, further comprising:
a cover connected to the stopper section; and
a secondary seal compressed between a surface on the collar and the cover with cap connected to the collar.

18. A food chilling device according to claim 16, further comprising:
a first handle extending outward from the collar in a radial direction relative to the reference axis and having a first grip spaced from and oriented generally parallel to the reference axis.

19. A food chilling device according to claim 18, further comprising:
a second handle extending from the cap and having a second grip spaced from the cap away from open end of the body and oriented generally perpendicular to the reference axis.

20. A food chilling device according to claim 16, further comprising:
a T-shaped handle extending from the cap and having a grip spaced from the cap away from open end of the body and oriented generally perpendicular to the reference axis.
